(19) United States
(12) Patent Application Publication
(10) Pub. No.: US 2007/0084679 A1
(43) Pub. Date: Apr. 19, 2007

(54) Spring, a method of manufacturing such a spring and a disk brake including such a spring

(76) Inventors: Alain Barillot, Lagny (FR); Luc Stilhart, Damremont (FR); Nicola Tristano, Matera (IT); Franco Varese, Bitonto (Bari) (IT)

Correspondence Address: Robert Bosch Corporation, 2112 Mishawaka Avenue, PO Box 4721, South Bend, IN, 46637, US

(21) Appl. No.: 10/539,457

(22) PCT Filed: Dec. 17, 2003
(86) PCT No.: PCT/EP03/14362

§ 371 Date: Jun. 17, 2005

(30) Foreign Application Priority Data
Dec. 20, 2002 (FR) 0216462

(51) Int. Cl. F16D 65/38

(52) U.S. Cl. 188/73.39

(57) ABSTRACT

The present invention relates mainly to guide means for guiding brake pads in a longer-life disk brake, to a disk brake including such means, and to a method of manufacturing such means. The present invention mainly provides resilient guide means for resiliently guiding a friction element for a disk brake, said means being covered entirely and uniformly with a layer of electrically insulating material, wherein said layer is a varnish. The present invention is applicable mainly to the brake industry for motor vehicle brakes and in particular to the brake industry for private automobile brakes.

The present invention relates mainly to a spring for guiding brake pads in a longer-life disk brake, to a disk brake including such means, and to a method of manufacturing such means.

### BACKGROUND OF THE INVENTION

It is known that disk brake pads can be guided by guide springs. In order to reduce friction between the pads and the guide springs, stainless steel springs are used. Such springs have means for fixing by pinching onto a disk brake yoke and means for fastening to a brake pad. Each pad is mounted to slide at each of its side edges in a disk brake yoke by means of a respective one of two guide springs.

The yoke is made of cast iron and is coated with zinc so as to protect it from the corrosion caused by the outside elements such as rain or sea water, and made worse by the temperatures to which the disk brakes are subjected.

However, because of the difference between the electrochemical potentials of stainless steel and of zinc (difference of about 1150 millivolts (mV)), galvanic-type corrosion between the guide springs and the layer of zinc covering the disk brake yoke can appear and damage the coating of the yoke, which can ultimately prevent the brakes from working properly.

In order to combat that type of corrosion, it is known that the layer of zinc covering the disk brake can be insulated from the guide springs by disposing grease at the points of contact between the springs and the yoke. However, grease has poor thermal stability when the brake pads are heated by being subjected to large forces.

It is also known that a rubber coating can be used on the guide springs in order to insulate the spring from the yoke. Unfortunately, the method of applying the rubber to the springs is complex and costly.

### OBJECTS AND SUMMARY OF THE INVENTION

An object of the present invention is to provide a disk brake that offers increased operating safety.

Another object of the present invention is to provide a disk brake that has a longer life.

Another object of the present invention is to provide a disk brake that is inexpensive.

Another object of the present invention is to provide brake pad guide springs that are simple to make.

These objects are achieved by a disk brake including brake pad guide springs each of which is coated with a thin synthetic protective layer or with a varnish.

In other words, the spring is insulated from the yoke by a small thickness of electrically insulating material that is suitable for withstanding the severe operating conditions of a brake, that is simple to apply, and that is low in cost.

In addition, the spring of the present invention offers the advantage of improving the sliding by reducing friction.

The present invention provides resilient guide means for resiliently guiding a friction element for a disk brake, said means being covered entirely and uniformly with a layer of electrically insulating material, wherein said layer is a varnish.

The present invention also provides guide means comprising first and second portions organized so that the spring is substantially shaped in the shape of the numeral 5.

The present invention also provides guide means wherein the first portion receives a projecting element that projects from a disk brake yoke, and wherein the second portion slidably receives a lug on the friction element.

The present invention also provides a disk brake comprising a yoke, a caliper, and at least two friction elements, said friction elements being mounted to slide in the yoke by means of two resilient guide means, wherein said resilient means are guide means of the present invention.

The present invention also provides a disk brake wherein the caliper is a floating caliper mounted to slide relative to the yoke by means of columns secured to the yoke.

The present invention also provides a disk brake wherein said caliper is provided with a piston which, when braking is operated, applies the friction elements against a brake disk.

The present invention also provides a disk brake wherein said piston is moved via a hydraulic fluid under pressure.

The present invention also provides a method of manufacturing resilient guide means for resiliently and slidably guiding disk brake pads, which method includes a step in which a spring steel blade is folded, said method also including a step following the folding step and consisting in covering the blade with an electrically insulating varnish.

The present invention also provides a method wherein the varnish is applied to the blade by spraying.

The present invention also provides a method wherein the varnish is applied by immersing the blade in a bath of varnish.

### BRIEF DESCRIPTION OF THE DRAWINGS

The present invention will be better understood on reading the following description with reference to the accompanying figures, in which:

FIG. 1 is a plan view of a disk brake of the present invention; and

FIG. 2 is a detail view of the disk brake shown in FIG. 1.

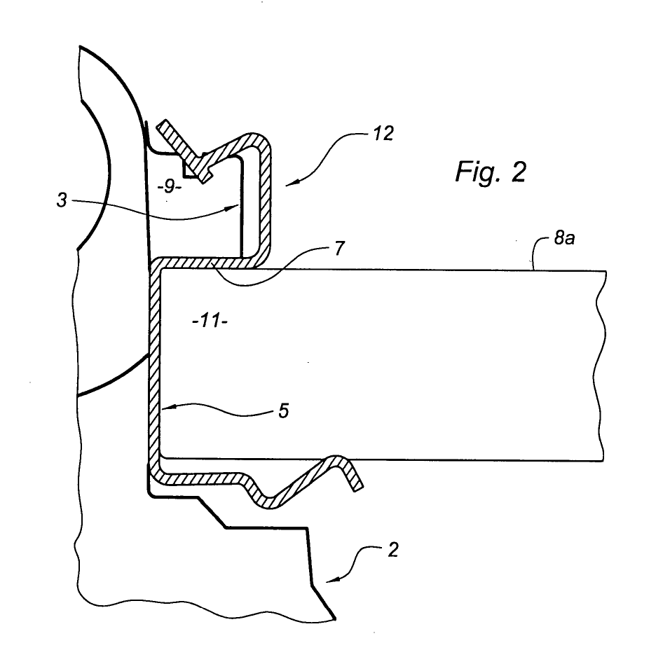

### MORE DETAILED DESCRIPTION

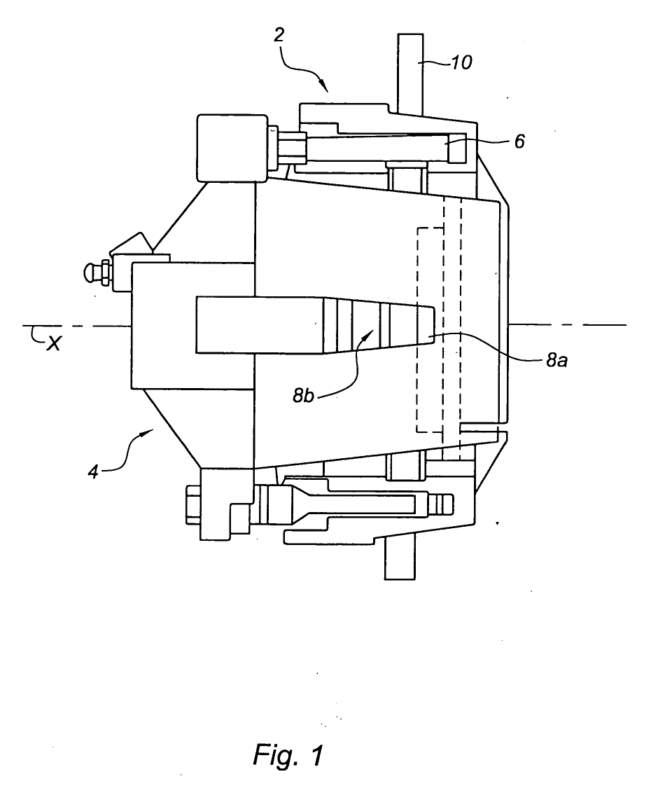

FIG. 1 shows a disk brake of the present invention including a yoke 2 secured to a wheel hub, a floating caliper 4 mounted to slide relative to the yoke 2 about guide elements or “columns” 6 secured to the yoke 2 and acting, during braking, to apply friction elements or brake pads 8a, 8b against a brake disk 10 that is constrained to rotate with the wheel.

The disk brake is provided with at least two brake pads 8a, 8b disposed on either side of the disk brake 10, and which, during braking, come to be applied against respective ones of first and second faces of the brake disk.

The pads are mounted to slide in the yoke 2 by means of resilient guide means 12 mounted on the yoke along an axis X of the brake disk, which means can, in known manner, be referred to as “guide springs”.

The caliper 4 is provided with at least one piston that is moved during braking, e.g. by a fluid under pressure, e.g. brake fluid, or by an electric motor and a nut-and-bolt assembly.

When braking is operated, the piston moves the first pad 8a towards the brake disk so as to apply it against the first face of the brake disk 10. In reaction, the caliper moves in the direction opposite to the direction in which the first pad 8a moves, and applies the second pad 8b against the second face of the brake disk opposite from the first face.

The disk brake pad guide spring 12 of the present invention is made up of first and second U-shaped portions 3 and 5 interconnected by a common branch 7 so as to form substantially the shape of the numeral 5.

The portion 3 is suitable for co-operating with a projecting element or “lug” 9 on the yoke, the shape of the lug being complementary to the inside shape of the portion 3 in which it is pinched, thereby enabling the spring 12 to be secured to the yoke.

The spring 12 is advantageously provided with fins (not shown) extending from the branch 7 perpendicularly to the direction in which the pad moves and at the portion 3 in order to consolidate the securing of the spring 12 relative to the yoke 2.

The portion 5 slidably and transversely receives a lug 11 projecting from the brake pad.

The guide spring 12 is made of spring steel, advantageously of stainless steel, by folding.

After folding, the blade of steel is coated with a varnish forming an electrical insulator of small thickness.

The varnish is applied uniformly over the entire surface of the guide spring, e.g. by spraying and or by immersion in a bath.

A disk brake is indeed obtained whose life is made longer by the fact that its resistance to corrosion is improved.

Naturally, the present invention also applies to a disk brake including a fixed caliper provided with at least two pistons, each of which applies a pad against the disk whenever braking is operated.

Naturally, the disk brake can also have more than two brake pads.

The present invention is applicable mainly to the brake industry for motor vehicle brakes, and in particular for private automobile brakes.

In the claims:

1. Resilient guide means for resiliently guiding a friction element for a disk brake, said means being covered entirely and uniformly with a layer of electrically insulating material, wherein said layer is a varnish.

2. The guide means according to claim 1, including a spring having first and second portions organized so that the spring is substantially shaped in the shape of the numeral 5.

3. The guide means according to claim 2, wherein the first portion receives a projecting element that projects from a disk brake yoke, and wherein the second portion slidably receives a lug on the friction element.

4. The guide means according to claim 1 wherein said disk brake includes a yoke, a caliper, and at least two friction elements, said friction elements being mounted to slide in the yoke by means of two resilient guide means.

5. The guide means according to claim 4 wherein said caliper is a floating caliper mounted to slide relative to the yoke by means of columns secured to the yoke.

6. The guide means according to claim 5, wherein said caliper is provided with a piston which, when braking is operated, applies the friction elements against a brake disk.

7. The guide means according to claim 6, wherein said piston is moved via a hydraulic fluid under pressure.

8. A method of manufacturing resilient guide means for resiliently and slidably guiding disk brake pads, which method includes a step in which a spring steel blade is folded, said method also including a step following the folding step and consisting in covering the blade with an electrically insulating varnish.

9. A method according to claim 8, wherein the varnish is applied to the blade by spraying.

10. A method according to claim 8, wherein varnish is applied by immersing the blade in a bath of varnish.
